(19) United States
(12) Patent Application Publication
(10) Pub. No.: US 2005/0184796 A1
(43) Pub. Date: Aug. 25, 2005

(54) Voltage generation circuit

(75) Inventor: Shinya Yamase, Ota-shi (JP)

Correspondence Address: Barry E. Bretschneider;Morrison & Foerster LLP, Suite 300, 1650 Tysons Boulevard, McLean, VA, 22102, US

(73) Assignee: Sanyo Electric Co., Ltd., Moriguchi-city (JP)

(21) Appl. No.: 11/057,369

(22) Filed: Feb. 15, 2005

(30) Foreign Application Priority Data
Feb. 20, 2004 (JP) 2004-044990

(51) Int. Cl. G05F 3/02

(52) U.S. Cl. 327/538

(57) ABSTRACT

This invention provides a voltage generation circuit generating a voltage having temperature dependence, where a diode generating a voltage having temperature dependence is built in an IC, and voltage steps between the voltages divided by resistors and temperature dependences of the voltages are constant. A voltage Vref having no temperature dependence and a voltage Vd1 having temperature dependence are generated. Voltages V11 and V12 formed by dividing the voltage Vref by resistors are generated. Then, voltages d1, V11, and V12 are arithmetically processed by a first operational amplifier for arithmetical processing and a second operational amplifier for arithmetical processing to form voltages VH1 and VL1. A voltage difference between the voltages VH1 and VL1 becomes a constant voltage which is removed with temperature dependence, being expressed by a following mathematical expression. VH1−VL1=mag×(V12−V11)

### CROSS-REFERENCE OF THE INVENTION

This invention is based on Japanese Patent Application No. 2004-044990, the content of which is incorporated by reference in its entirety.

### BACKGROUND OF THE INVENTION

1. Field of the Invention

This invention relates to a voltage generation circuit, particularly, to a voltage generation circuit for generating a voltage having temperature dependence.

2. Description of the Related Art

FIG. 3 shows a circuit diagram of a voltage generation circuit for generating a voltage having temperature dependence of conventional art. A resistor R21 and a diode D2 are connected in series between a supply voltage Vdd and a ground voltage, and a voltage Vd2 having temperature dependence is generated from a connection point thereof. This voltage Vd2 is almost equal to a forward voltage of the diode D2, and has a temperature dependence of −1.8 mV/° C. reflecting its temperature characteristics. An operational amplifier OP21 amplifies this voltage Vd2 and outputs a voltage VH2. Its amplification factor is (r22+r23) /r23. The r22 and r23 designate resistances of resistors R22 and R23, respectively.

This voltage VH2 is supplied to a high voltage side of a resistor voltage dividing circuit 50 as a voltage source. The resistor voltage dividing circuit 50 is formed by connecting n pieces of resistors R1, R2, . . . Rn in series between the voltage VH2 and a ground voltage and connecting (n+1) pieces of transmission gates TG1 TG2, . . . TGn+1 to connection points of the resistors R1, R2, . . . Rn respectively. When one of these transmission gates TG1, TG2, . . . TGn+1 turns on, a divided voltage at the connection point of the transmission gate is outputted through the transmission gate. The voltage outputted from the transmission gate is converted into a low impedance voltage through an operation amplifier OP22 for a voltage follower and then outputted.

Thus, in this circuit, a required voltage can be obtained by dividing the amplified voltage VH2 having temperature dependence by the resistor voltage dividing circuit 50. The relevant technology is disclosed in Japanese Patent Application Publication No. 2003-108241.

However, there have been two problems in such a conventional circuit. First, because the forward voltage of the diode D2 should be set, the diode D2 can not be built in an IC and should be attached to an outside of the IC.

Under a circuit requirements that the supply voltage is 5V±10%, the temperature dependence of the output voltage VH2 is −20 mV/° C., and an operation temperature range is −25° C. to 75° C., the operation amplifier OP21 is set to have the eleven times amplification factor corresponding to the temperature dependence of −20 mV /° C., (this is, in fact, 20/1.8 times amplification factor, but the eleven times amplification factor is used here for simplifying the description). Since a lowest value of the supply voltage is 4.5V, the forward voltage of the diode D2 at the temperature of −25° C. is 4.5/11=0.409V.

Therefore, the forward voltage of the diode D2 at room temperature (25° C.) is 4.5/11−0.0018×50=0.319V. For obtaining the diode forward voltage of about 0.3V at a diode built in the IC having a general pattern size, a current flowing therein should be limited to several 10 pA to 100 pA and the resistance of the resistor connected to the diode in series should be several 10 GΩ or more, which is not practical. Therefore, a discrete diode where a large current (μ A order) can flow for obtaining the low diode forward voltage need be attached to the outside of the IC.

The second problem is that voltage steps between the divided voltages by the resistor voltage dividing circuit 50 depend on the temperature and the temperature dependences of the divided voltages differ from each other. FIG. 4 is a view showing temperature characteristics of an output voltage of the resistor voltage dividing circuit 50 of FIG. 3. The voltage VH2, the voltage VL2 as a ground voltage, and an intermediate voltage Cent2 of these voltages are shown in FIG. 4. The voltage VH2 which is the output of the operational amplifier OP21 used as an amplifier has a predetermined temperature dependence. When this voltage VH2 is divided toward the voltage VL2 having no temperature dependence, the voltage steps between the divided voltages change depending on the temperature and the temperature dependences of the divided voltages also change.

### SUMMARY OF THE INVENTION

The invention provides a voltage generation circuit that includes a first voltage generation circuit outputting a first voltage having no temperature dependence, a second voltage generation circuit generating a second voltage having a temperature dependence, a first resistor voltage dividing circuit generating a third voltage and a fourth voltage by dividing the first voltage and having a first output terminal outputting the third voltage and a second output terminal outputting the fourth voltage, and a first operational amplifier including a positive input terminal receiving the second voltage, a negative input terminal connected through a first resistor to the first output terminal of the first resistor voltage dividing circuit, and an output terminal. A second resistor is connected between the output terminal of the first operational amplifier and the negative input terminal of the first operational amplifier. The device also includes a second operational amplifier including a positive input terminal receiving the second voltage, a negative input terminal connected through a third resistor to the second output terminal of the first resistor voltage dividing circuit, and an output terminal. A fourth resistor is connected between the output terminal of the second operational amplifier and the negative input terminal of second operational amplifier.

### BRIEF DESCRIPTION OF THE DRAWINGS

FIG. 1 is a circuit diagram of a voltage generation circuit of an embodiment of the invention.

FIG. 2 is a view showing temperature characteristics of the voltage generation circuit of the embodiment of the invention.

FIG. 3 is a circuit diagram of a voltage generation circuit of the conventional art.

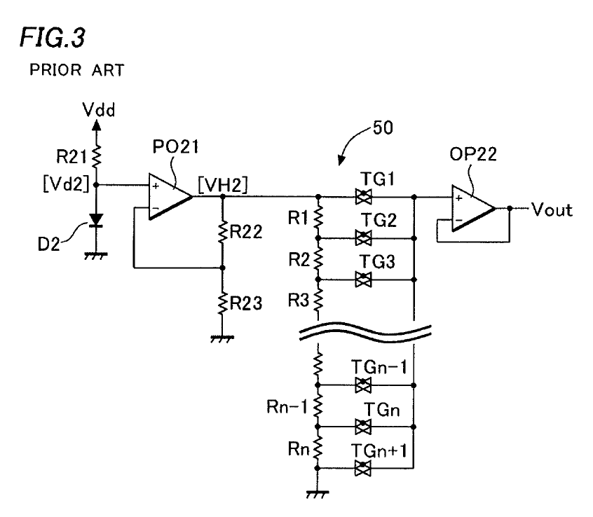

FIG. 4 is a view showing temperature characteristics of the voltage generation circuit of the conventional art.

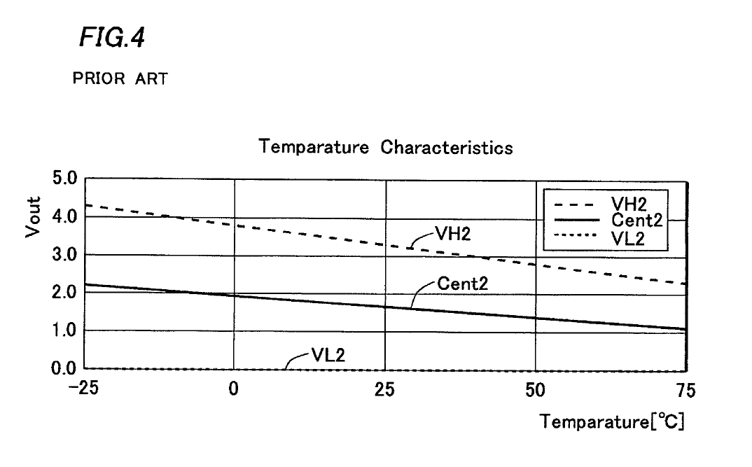

### DETAILED DESCRIPTION OF THE INVENTION

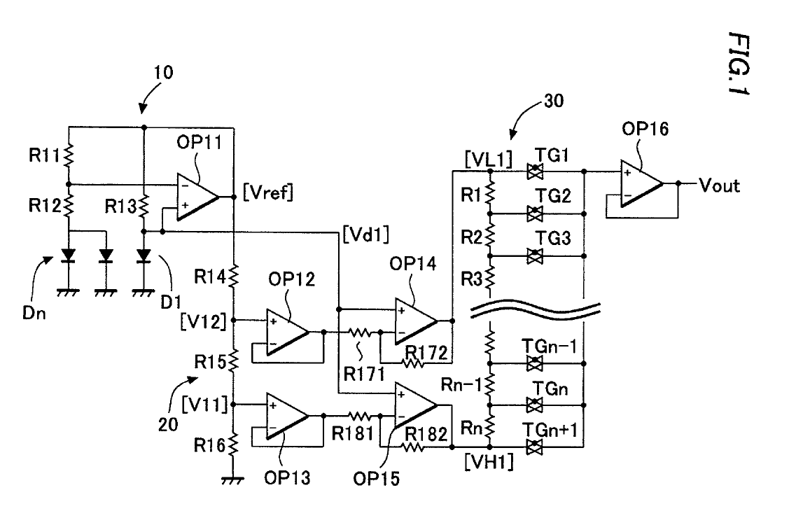

Next, a voltage generation circuit of an embodiment of the invention will be described with reference to drawings. FIG. 1 is a circuit diagram of this voltage generation circuit. A numeral 10 designates a band gap circuit for generating a voltage Vref having no temperature dependence, which is formed of resistors R11, R12, R13, a diode D1, a plurality of parallel connected diodes Dn, and an operational amplifier OP11. A voltage Vd1 having temperature dependence is generated from a connection point of the resistor R13 and the diode D1 in this circuit. It is noted that the voltage Vd1 having the temperature dependence can be generated from a connection point of the resistor R13 and a bipolar transistor instead of the diode D1. Furthermore, the band gap circuit 10 using an operational amplifier OP11 is employed here, but a band gap circuit of a constant current type which is generally known in the art can be employed instead.

A numeral 20 designates a first resistor voltage dividing circuit for dividing the voltage Vref, which is formed of resistors R14, R15, and R16 connected in series between an output of the operational amplifier OP11 and a ground voltage. A voltage V12 is generated at a connection point of the resistors R14 and R15, and a voltage V11 lower than the voltage V12 is generated at a connection point of the resistors R15 and R16.

OP14 designates a first operational amplifier for arithmetic processing where a positive input terminal (+) is applied with the voltage Vd1 and a negative input terminal (−) is inputted with the voltage V12 through a resistor R171 after the voltage V12 is converted into a low impedance voltage by an operational amplifier for a voltage follower OP12. A resistor R172 is connected between an output and the negative input terminal (−) of the first operational amplifier for arithmetic processing OP14.

OP15 designates a second operational amplifier for arithmetic processing where a positive input terminal (+) is applied with the voltage Vd1 and a negative input terminal (−) is inputted with the voltage V11 through a resistor R181 after the voltage V11 is converted into a low impedance voltage by an operational amplifier for a voltage follower OP13. A resistor R182 is connected between an output and the negative input terminal (−) of the second operational amplifier for arithmetic processing OP15.

A second resistor voltage dividing circuit 30 is formed by connecting n pieces of resistors R1, R2, . . . Rn in series and by connecting (n+1) pieces of transmission gates TG1, TG2, . . . TGn+1 to connection points of these resistors respectively, between an output voltage VL1 of the first operational amplifier for arithmetic processing OP14 and an output voltage VH1 of the second operational amplifier for arithmetic processing OP15 (VH1>VL1). When one of these transmission gates TG1, TG2, . . . TGn+1 turns on, a divided voltage at the connection point of the transmission gate is outputted through the transmission gate. This voltage outputted from the transmission gate is converted into a low impedance voltage through an operational amplifier for a voltage follower OP16.

The output voltage VH1 of the second operational amplifier for arithmetic processing OP15 is expressed by a following mathematical expression.
VH1={1+(r182/r181)}×Vd1 −(r182/r181)×V11
The output voltage VL1 of the first operational amplifier for arithmetic processing OP14 is expressed by a following mathematical expression.
VL1={1+(r172/r171)}×Vd1−(r172/r171)×V12

In these mathematical expressions, r171, r172, r181, and r182 designate resistances of the resistors R171, R172, R181, and R182, respectively. In the mathematical expressions, the first term represents a voltage having temperature dependence, and the second term represents a constant voltage having no temperature dependence. The voltage VH1 and the voltage VL1 are low voltages since these are obtained by a difference between the voltages of the first and second terms, respectively, even if the diode voltage Vd1 or its coefficient is somewhat high. Therefore, the supply voltage can be set low. Furthermore, the diode voltage Vd1 can be set high, so that the diodes can be built in an IC.

Here, under the condition that r172/r171=r182/r181=“mag,” set for making the temperature dependences of the voltages VH1 and VL1 the same, i.e., equal resistance ratios, the voltages VH1 and VL1 are expressed by a following rearranged mathematical expressions.
VH1={1+mag}×Vd1−mag×V11
VL1={1+mag}×Vd1−mag×V12
A voltage difference between the voltages VH1 and VL1 is expressed by a following mathematical expression, and becomes a constant voltage where temperature dependence is removed.
VH1−VL1=mag×(V12−V11)

Specifically, under a circuit setting where the supply voltage is 5V±10%, the temperature characteristics is −20 mV/° C., the operational temperature range is −25 to 75° C., and the output voltage range is 1V, the voltage change from the median temperature, i.e., 25° C. is ±1.0V, so that the values of the VH1 and VL1 at 25° C. are set to 3V and 2V, respectively, with consideration for the supply voltage.

The diode voltage Vd1 from the diode D1 of the band gap circuit 10 is set to 0.6V (at 25° C.), and the temperature dependence is set to −1.8 mV /° C. A voltage Vref from the band gap circuit 10 is set to 1.2V, which is a general value. Under this condition, values of circuit elements will be calculated as follows.

(1+mag)=11 is set from the required temperature characteristics of the temperature dependence of −20 mV/° C. Although (1+mag)=20/1.8 exactly, here it is assumes that (1+mag)=11 for simplifying the description. Next, the voltages V11 and V12 are calculated based on mag and the voltage values of the voltages Vd1, VH1, and VL1 at 25° C.
3.0=(1+10)×0.6−10×V11
2.0=(1+10)×0.6−10×V12

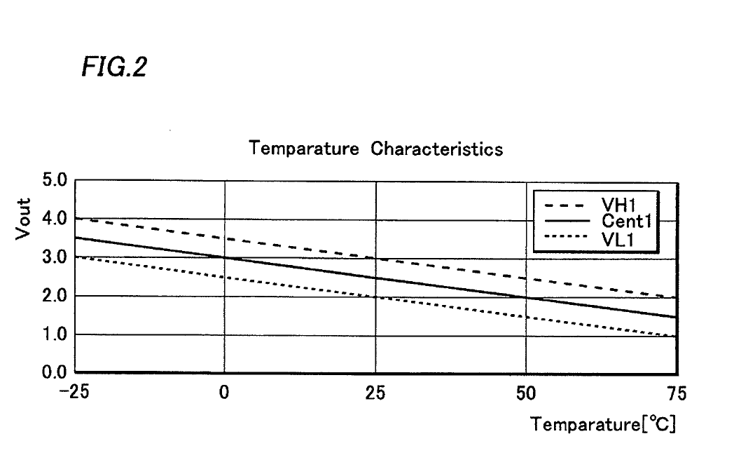

From these mathematical expressions, V11=0.36 and V12=0.46 are obtained. Therefore, a resistance ratio of the resistors R14, R15, and R16 of the first resistor voltage dividing circuit 20 can be set to r14:r15:r16=74:10:36 and r171:r172=r181:r182=1:10. FIG. 2 is a view showing temperature characteristics of an output voltage of this voltage generation circuit. FIG. 2 shows the voltage VH1, the voltage VL1, and an intermediate voltage Cent1 of these voltages based on the above circuit specification setting.

Therefore, in the voltage generation circuit of this embodiment, the voltage from the diode D1 can be set to a large value 0.6V, so that the resistance of the resistor R13 connected to the diode D1 in series can be set low. Accordingly, the diode D1 can be built in the IC. Furthermore, the circuit of this embodiment can be operated with a lower supply voltage than the conventional device. The voltage steps between the voltages divided by the second resistor voltage dividing circuit 30 are constant and the temperature dependences of the voltages are also constant.

1. A voltage generation circuit, comprising:
a first voltage generation circuit outputting a first voltage having no temperature dependence;
a second voltage generation circuit generating a second voltage having a temperature dependence;
a first resistor voltage dividing circuit generating a third voltage and a fourth voltage by dividing the first voltage and comprising a first output terminal outputting the third voltage and a second output terminal outputting the fourth voltage;
a first operational amplifier comprising a positive input terminal receiving the second voltage, a negative input terminal connected through a first resistor to the first output terminal of the first resistor voltage dividing circuit, and an output terminal, a second resistor being connected between the output terminal of the first operational amplifier and the negative input terminal of the first operational amplifier; and
a second operational amplifier comprising a positive input terminal receiving the second voltage, a negative input terminal connected through a third resistor to the second output terminal of the first resistor voltage dividing circuit, and an output terminal, a fourth resistor being connected between the output terminal of the second operational amplifier and the negative input terminal of second operational amplifier.

2. The voltage generation circuit of claim 1, wherein a ratio of a resistance of the first resistor to a resistance of the second resistor is equal to a ratio of a resistance of the third resistor to a resistance of the fourth resistor.

3. The voltage generation circuit of claim 1, further comprising a second resistor voltage dividing circuit connected between the output terminal of the first operational amplifier and the output terminal of the second operational amplifier.

4. The voltage generation circuit of claim 1, further comprising a third operational amplifier converting the third voltage into an output voltage of a low impedance and a fourth operational amplifier converting the fourth voltage into an output voltage of a low impedance.

5. The voltage generation circuit of claim 1, wherein the first voltage generation circuit is a band gap circuit.

6. The voltage generation circuit of claim 1, wherein the second voltage generation circuit is a diode.

7. The voltage generation circuit of claim 1, the second voltage generation circuit is a bipolar transistor.
